(19) United States
(12) Patent Application Publication
(10) Pub. No.: US 2018/0161666 A1
(43) Pub. Date: Jun. 14, 2018

(54) Casino Speed Reader

(71) Applicant: 4-D Gaming, LLC, Temecula, CA (US)

(72) Inventors: Kyle Dennis Morris, Temecula, CA (US); Steven Kenneth Wright, Menifee, CA (US); Paul Alan Trieglaff, Detroit Lakes, MN (US)

(21) Appl. No.: 15/793,013

(22) Filed: Oct. 25, 2017

Related U.S. Application Data
(60) Provisional application No. 62/394,228, filed on Sep. 14, 2016.

(51) Int. Cl. A63F 1/18; A63F 1/10; A63F 1/06; A63F 11/00; G06F 17/30; G06E 1/02; G06T 1/00

(52) U.S. Cl. CPC A63F 1/18; A63F 1/10; A63F 1/067; A63F 2011/0072; G06F 17/30256; G06E 1/02; G06T 1/0007; A63F 11/0051

(57) ABSTRACT

An apparatus, such as for use by a dealer in a game utilizing game pieces, such as playing cards or tiles, is disclosed. The dealer may deal a plurality of the game pieces to the dealer as well as to one or more other players. The apparatus may assist the dealer with setting the dealer's own dealt game pieces. The apparatus may include a camera for scanning the dealer's dealt game pieces. The apparatus may further include a central processor coupled to the camera for determining the relative rank of each of the dealer's game pieces, and for determining an optimal sub-grouping of the dealer's game pieces, and an indicator for identifying which of the dealer's game pieces are associated with each of the sub-groups.

### FIELD OF THE INVENTION

The present invention relates to an apparatus that may allow for substantially instantaneous reading of identifying information on game pieces, such as playing cards, tiles and the like, and sorting the game pieces before the game pieces are exposed to players and/or a dealer.

The apparatus may use cameras and a computer processer to determine the best way for a hand to be played and/or set, or the device can identify, order and/or eliminate specific game pieces in all relevant games. The apparatus may allows for an entirely new type of game to be played where partial information about specific pieces or exact information about the content of a game may be revealed at an interval that was previously unavailable.

### BACKGROUND

In typical casino games, game pieces, such as playing cards, may be dealt by a casino dealer, and subsequently exposed at specific intervals during the hand. According to rules of certain card games, prior to the dealer exposing his/her cards, the dealer may first separate his/her cards into two or more separate groups, or hands.

According to rules of Pai Gow poker, the dealer may deal seven cards to his/herself, as well as to other players at the table. The players may set their cards, each into a five-card hand (sometimes referred to as a ‘back hand’) and a two-card hand (sometimes referred to as a ‘front hand’), keeping their cards face down. The Pai Gow dealer may then expose his/her seven cards to the players, and then may set his/her seven cards into a five-card front hand and a two-card back hand. According rules of certain games, some of the dealt cards may be discarded, before the cards to be played are “set.” Alternatively the dealer may only expose one of his/her hands, such as the hair hand, before the players set their respective hands.

Before the dealer sets his/her cards into two (or possibly more, depending upon the game) hands, the dealer must determine the proper composition of his/her cards for each hand. This determination may be done pursuant to some extensive rules, which may be time consuming and, if not performed properly, may lead to a less than desired composition.

### SUMMARY

In accordance with the present invention, a casino card reader is provided. The card reader may scan each of the dealer's cards, or other game pieces such as tiles, to determine the makeup of the dealer's hand (i.e., the values and suits of the cards) prior to setting and exposing the dealer's cards to the other players. The card reader may assist the dealer to eliminate the potential for mistakes in setting hands, reduces cheating and allows for additional games to be played in a secure gaming environment where there is no potential for information to be prematurely exposed.

The reader may assist the dealer set the hand by identifying which physical cards should be turned over for the various parts of the hand, not just by identifying the cards by value, such as on a video screen. The reader may assist the dealer in setting the hand faster by determining the actual cards, and doesn't require the dealer to turn over all dealt cards at once, and fish out the correct values.

It is contemplated the reader may be used to determine which game pieces to discard and which game pieces the house will keep to form their final hand.

It is further contemplated the reader may be used to determine the best way to play a hand and display to the dealer in a matter which helps the dealer set the hand accurately and quickly.

It is further contemplated the reader may be used to detect the actual value of the game pieces but only display partial information about the hand like the suits, number values or the small, medium and large values (sometimes referred to as 4-D values) of some or all of the game pieces in the hand.

It is further contemplated the reader may be used to connect to an additional display device for information to be displayed to the players and the dealer.

It is further contemplated the reader may identify specific groups of game pieces containing specific value cards. This could be all pairs, specific pairs, only straights, flushes, numerical totals, ranges, or the like.

It is further contemplated the reader may be used to direct the dealer to place certain game pieces in specific positions. After the game pieces have been read, the information may be sent to a computer processor and assist the dealer in placing the game pieces in the correct positions.

It is further contemplated the games played using the reader may be played on a computer, tablet, phone or similar device.

### DESCRIPTION OF THE DRAWINGS

For a more complete understanding of the disclosure, reference should be made to the following detailed description and accompanying drawings, wherein:

FIG. 1 is a plan view of one embodiment of the speed-reader in accordance with present invention, including eight slots;

FIG. 2 is a side sectional view of the speed-reader of FIG. 1, modified to include seven slots;

FIGS. 3-9 illustrate use of the speed-reader of FIG. 1 in conjunction with playing Pai Gow poker with conventional playing cards;

FIGS. 10A and 10B illustrate use of the speed-reader of FIG. 1 in conjunction with playing Pai Gow with Pai Gow tiles; and

FIG. 11 illustrates use of the speed-reader of FIG. 1 to identify a particular card such as a joker.

### DESCRIPTION OF THE PREFERRED EMBODIMENTS

While this invention is susceptible of embodiment in many different forms, there will be described herein in detail, specific embodiments thereof with the understanding that the present disclosure is to be considered an exemplification of the principles of the invention and is not intended to limit the invention to the specific embodiment illustrated.

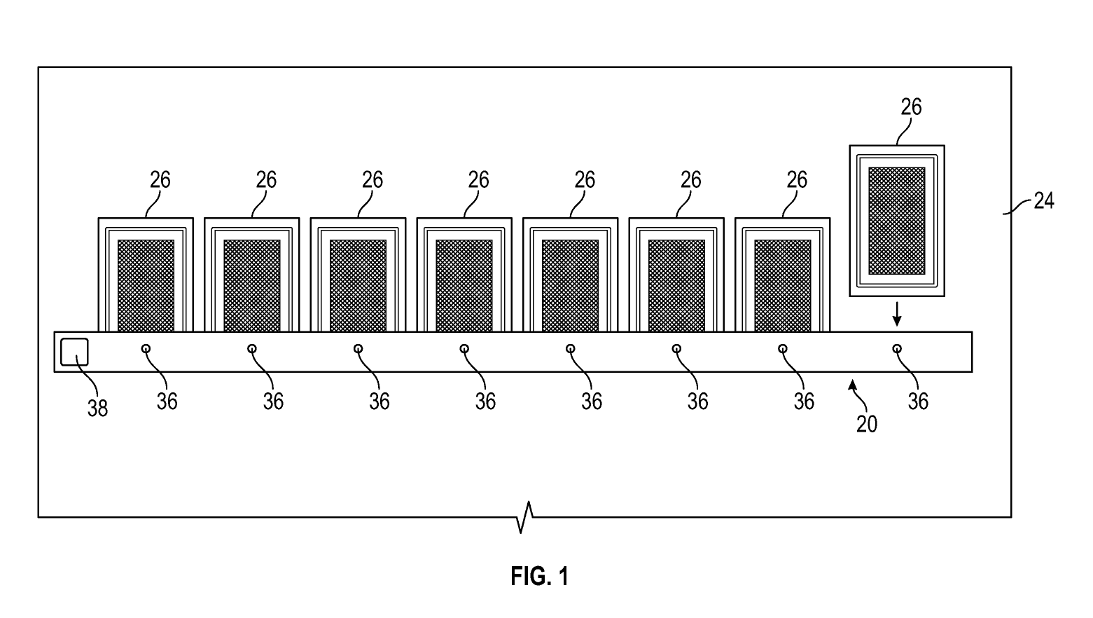

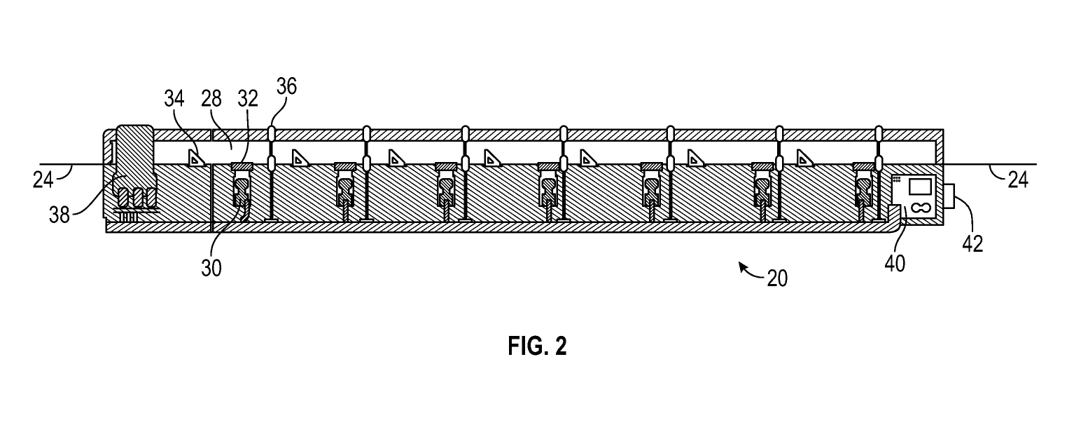

A reader, generally designated 20, in accordance with the invention is illustrated in FIGS. 1 and 2. The reader 20 is illustrated in FIG. 1 as viewed from above. The reader 20 may sit on top of, or may be recessed into, a card table 24. The reader may also be incorporated into, and be a part of, the dealer's chip tray.

Also illustrated in FIG. 1 are eight conventional playing cards 26.

A side sectional view of the reader 20 is illustrated in FIG. 2. The reader 20 of FIG. 2 is shown recessed into the card table 24.

Referring to FIGS. 1 and 2, the reader 20 may include a plurality of slots 28, one for receiving a respective playing card 26. The reader 20 illustrated in FIG. 1 includes eight slots 28, while the reader 20 illustrated in FIG. 2 includes seven slots 28. It should be understood that the reader 20 may include other quantities of the slots 28, depending upon needs and requirements of the game to be played. Additionally the reader 20 may be configured such that not all of the slots 28 are utilized for a particular game.

The reader 20 may further include eight cameras 30, such as video cameras, and associated camera covers 32, one associated with each of the eight slots 28. Each of the cameras 30 may face upwardly, towards it respective one of the slots 28. The reader 20 may still further include eight card backstops 34. The backstops 34 may limit the distance playing cards 26 may be inserted into their respective slots 28.

The reader may further include eight card indicator lights 36, which may be multi-colored LED indicator lights, one each associated with each of the eight slots 28. The card indicator lights 36 may also be dimmable. When illustrated as being illuminated, the indicator lights are shown in the drawings as 36′.

The reader may still further include a combination game button/indicator light 38, a microprocessor 40, and a power button 42.

When the reader 20 is recessed mounted in the card table 24, card openings into the slots may be substantially flush with an upper surface 24a of the card table 24, permitting the playing cards 26 to be slid into respective ones of the slots 28.

As the playing cards 26 are slid into their respective slots, the respective ones of the cameras 30 scan the playing cards 26 to determine the particular indicia (such as suit and value) of the playing cards 26. The cameras 30 may each be coupled to the microprocessor 40. The microprocessor 30 may be programmed to determine which one of the playing cards 26 are in each of the slots 28, and may be programmed to then determine how the playing cards 26 should be set.

Once the microprocessor has determined how the playing cards 26 should be set, the microprocessor 30 may illuminate the respective card indicator lights 36 in a manner to indicate and identify, to the dealer, card groupings. For example, when playing Pai Gow poker, the microprocessor 30 may cause the indicator lights 36 to indicate and identify the playing cards 26 forming the two card hand by illuminating their respective card indicator lights 36, such as green.

The reader 20 may have the individual card indicator lights 36 either illuminate when a playing card 26 is properly placed in the reader 20, or have the card indicator lights 36 dim when the playing cards 26 are positioned correctly. In some games the card indicator lights 36 might turn on as soon as the correct number of cards for the game are placed in the reader 20. In other games, the dealer may press a button, such as the game button/indicator light 38, to read the hand. It may depend on how the game play for that game works. Utilizing multi-color LED bulbs may permit a number of different colors. Alternatively the reader 20 may utilize multiple lights of different colors over each of the card reading slots 28.

Example Hand of Pai Gow Poker

The following is an example of playing Pai Gow poker utilizing the reader 20.

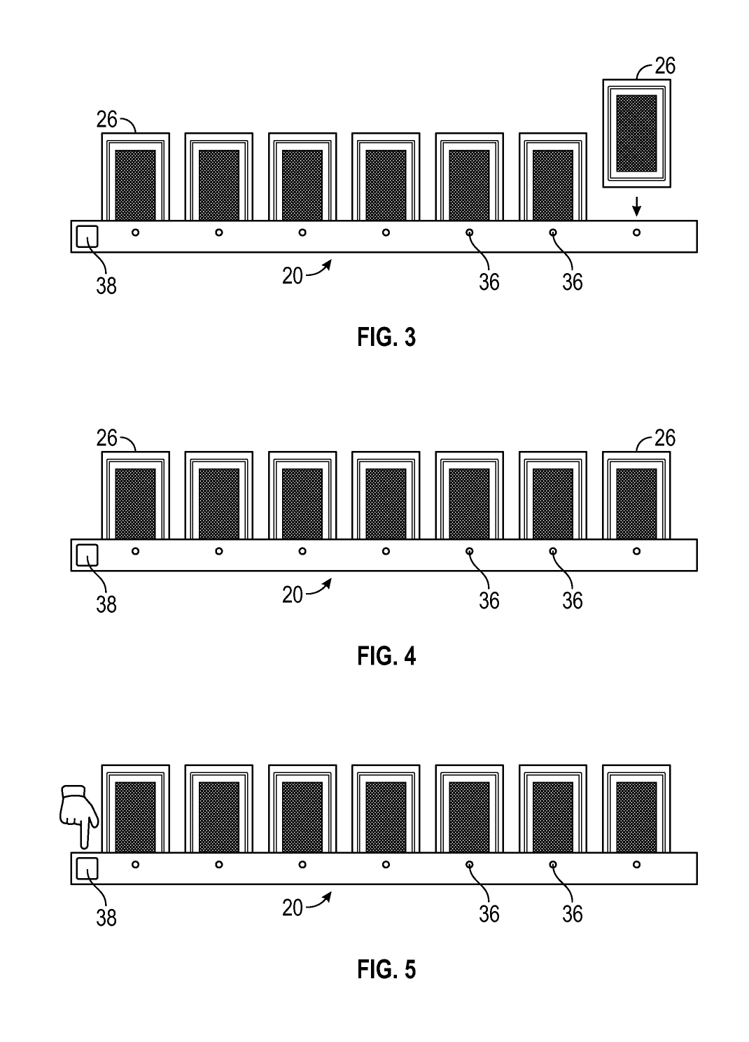

In FIG. 3, the playing cards 26 for the dealer (e.g., the house) may be inserted into the slots 28 of the reader 20.

As illustrated in FIG. 4, once all of the playing cards 26 have been placed in the reader 20, as may be sensed by the respective cameras 30, the microprocessor 40 illuminate the game button/indicator light 38, such as green, indicating to the dealer that all of the playing cards 26 have been properly.

As illustrated in FIG. 5, once all of the other players have set their respective hands, the dealer may actuate the game button/indicator light 38. Actuating the game button 38 may trigger the associated equipment.

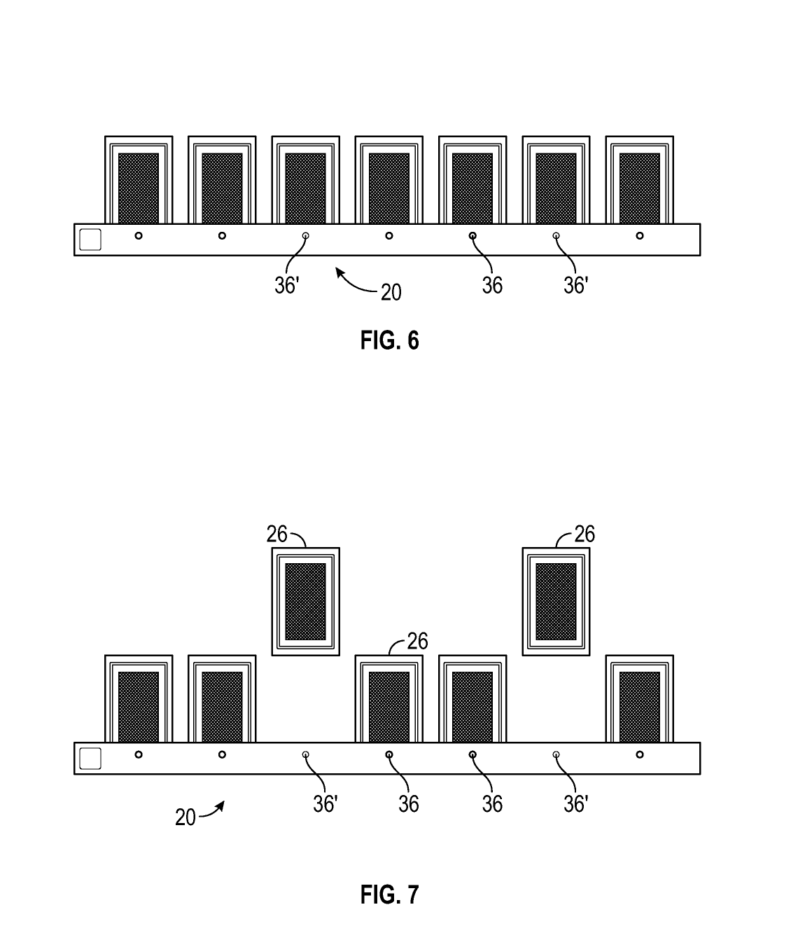

As illustrated in FIG. 6, actuation of the game button/indicator 38 may cause the microprocessor 40 to cause the cameras 30 to scan the respective playing cards 26, reading the respective values of the playing cards 26 in the house/dealer hand. The values of the seven cards will be fed into the microprocessor 40, and the microprocessor may determine a way for the hand to be set. Preferably the microprocessor 40 may be programmed to determine the best way for the dealer's hand to be set. The result of these calculations will be displayed by the card indicator lights 36. Once calculated, the microprocessor 40 may turn the game button/indicator light red, and may illuminate the card indicator lights 36, in front of two of the seven cards, red.

As illustrated in FIG. 7, the two cards indicated may be used to form the hair, or front hand.

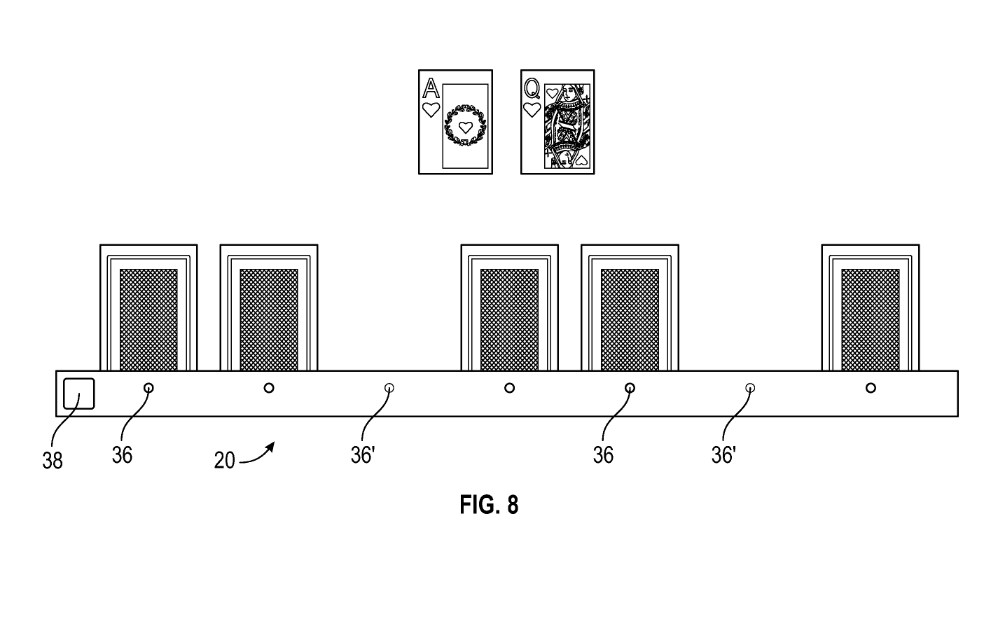

As illustrated in FIG. 8, the five remaining cards may be used to form the poker hand in back.

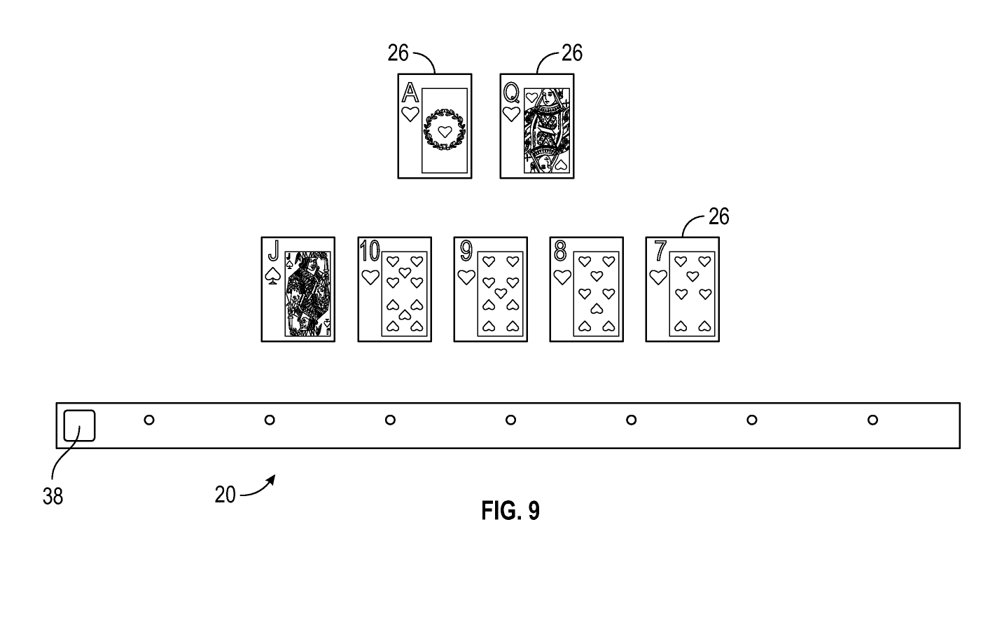

As illustrated in FIG. 9, once the five-card hand is removed, and all of the card slots 28 have been cleared, the microprocessor 40 may reset, and the reader may be ready to use again to set the next hand.

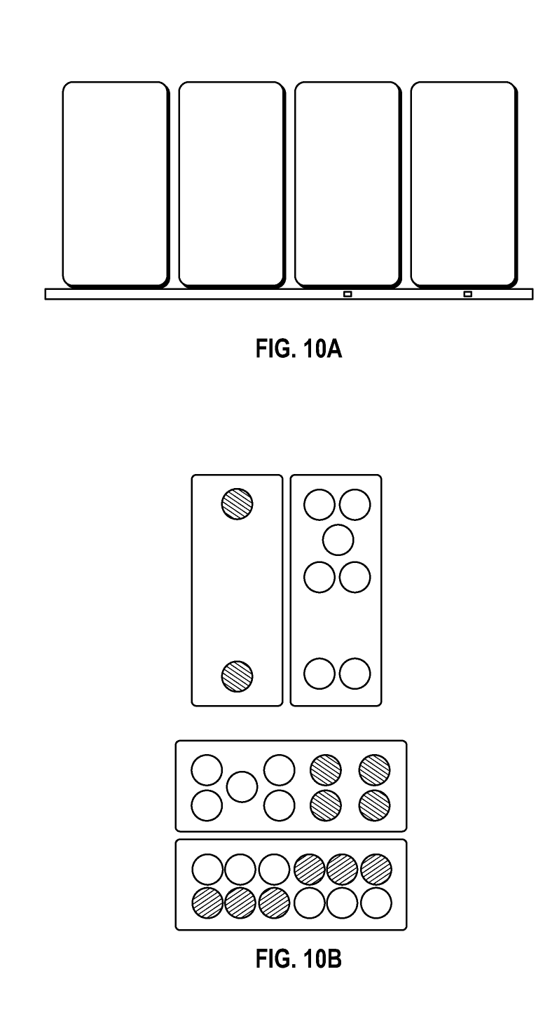

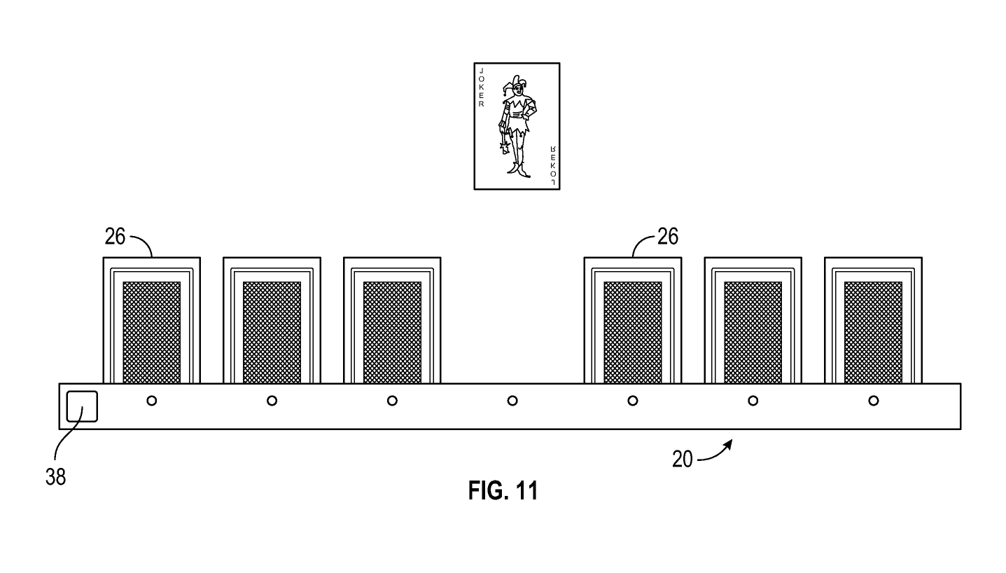

As illustrated in FIGS. 10A and 10B, the reader 20 may also be used with other game pieces, such as with Pai Gow Tiles. The determination of which tiles should be in front and which should go in back can increase the house edge, such as by 0.75%. The reader 20 may works in the same manner as described above with Pai Gow Poker, but the reader 20 may determines which two of the four tiles should be in the top hand.

Use with Other Games

A number of other games may become available when the reader 20 is added to the table.

No (“Know”) Joker Pai Gow Poker. When the Joker is detected in the dealer's hand it may be turned face up and shown to the players before they set their hands.

In an optional version, a detected joker is always removed from the dealer's hand (discarded) and may optionally be replaced by another card.

Side Bet: A side bet that may pay based on the value of the card discarded by the dealer.

Progressive: A progressive bet that pays based on the player having cards in their hand that are the same value as the card discarded by the dealer.

Other ways the reader 20 may be used include:

1) Identifying the highest or lowest card in a hand, before the entire hand is exposed.

2) Identifying cards of a specific suit, the cards in a hand of the same suit, or the cards in the hand with the largest number of a single suit.

3) Identifying if a dealer's hand will meet a qualifying requirement (Jacks or better for example) before the hand is turned over or exposed.

4) Identifying if a hand contains a joker or any other specific card.

5) Identifying completed hand rankings. (a straight for example).

6) Setting hands for play and identifying discards.

7) Reading the cards and deciding in what order to play the cards (for a “shedding style” game like spades or hearts).

8) Reading the cards in games where card values are combined and determining whether the hand will require additional cards to be completed. (totals in a game like baccarat or blackjack).

9) Identifying the 4-D value (small, medium or large) of a card or cards and displaying it to the players and the dealer without having to expose the actual value of the card. (giving away partial information about a card).

It is to be understood that this disclosure is not intended to limit the invention to any particular form described, but to the contrary, the invention is intended to include all modifications, alternatives and equivalents falling within the spirit and scope of the invention as defined by the appended claims.

1. For a game comprising a plurality of game pieces distributed to a plurality of game players, each of the game pieces having a relative rank amongst other ones of the game pieces, wherein the game includes a step of the players setting their respective plurality of game pieces into a plurality of sub-groups of game pieces, an apparatus for assisting one of the players setting the one of the player's game piece, comprising:
a camera for scanning each of the player's game pieces;
a central processor coupled to the camera for determining the relative rank of each of the scanned game pieces, and for determining an optimal sub-grouping of the player's scanned game pieces;
an indicator for identifying which of the game pieces is associated with each of the sub-groups.

2. The apparatus of claim 1 wherein the game pieces comprise playing cards.

3. The apparatus of claim 2 wherein the indicator provides information regarding the rank of the scanned playing cards.

4. The apparatus of claim 3 wherein the provided information comprises the small/medium/large value of the scanned playing cards.

5. The apparatus of claim 1 wherein the game pieces comprise playing tiles.

6. The apparatus of claim 1 wherein the indicator comprises an LED associated with each of the game pieces.

7. The apparatus of claim 1 including an actuator button for actuating the central processor to determine the optimal sub-grouping of the player's scanned game pieces.

8. For a game comprising a plurality of game pieces distributed as groups of game pieces to a respective plurality of game players, each of the distributed game pieces having a relative rank amongst other ones of the game pieces, wherein the game includes a step of the players setting their respective plurality of game pieces into a plurality of sub-groups of game pieces, an apparatus for assisting one of the players setting the one of the player's game piece, comprising:
a plurality of slots, wherein each of the slots is adapted to receive a respective one of the player's game pieces;
a camera associated with each of the slots, for scanning each of the player's game pieces when inserted in the respective slot;
a central processor coupled to the camera for determining the relative rank of each of the scanned game pieces inserted into the slots, and for determining an optimal sub-grouping of the player's scanned game pieces;
a visual indicator associated with each of the slots for identifying which of the game pieces is associated with each of the sub-groups.

9. The apparatus of claim 8, wherein the visual indicator comprises an LED disposed proximate its associated slot.

10. The apparatus of claim 8, wherein:
the apparatus is adapted for mounting recessed in a card table; and
the slots are adapted to be flush with the card table to permit the game pieces to be slid from the table into the slot.

11. The apparatus of claim 8, wherein the apparatus is incorporated in a dealer's chip tray.

12. The apparatus of claim 8, wherein:
the central processor determines which one of the scanned game pieces has particular ranking; and
the central processor actuates the indicator associated with the game piece determined to have the particular ranking.

13. The apparatus of claim 8, wherein the central processor determines if the player's hand meets a qualifying requirement.

14. The apparatus of claim 8 wherein the central processor actuates one of the visual indicators to identify if one of the player's game pieces includes a particular game piece.

15. The apparatus of claim 8, wherein the central processor identifies completed hand rankings.

16. The apparatus of claim 8, wherein the central processor identifies game pieces for discard.

17. The apparatus of claim 8, wherein the central processor identifies an order to play the game pieces.

18. The apparatus of claim 8, wherein the central processor determines whether the player's group of game pieces requires additional game pieces.

19. The apparatus of claim 8, wherein the central processor determines the small/medium/large value of at least one of the game pieces and indicates displays the determined small/medium/large value to the other players.
